(19) United States
(12) Patent Application Publication
(10) Pub. No.: US 2010/0147326 A1
(43) Pub. Date: Jun. 17, 2010

(54) INTERDENTAL CLEANER WITH DENTAL FLOSS

(76) Inventor: Sung Han Kang, Jakarta Selatan (ID)

Correspondence Address: RATNERPRESTIA, P.O. BOX 980, VALLEY FORGE, PA, 19482, US

(21) Appl. No.: 12/431,851

(22) Filed: Apr. 29, 2009

(30) Foreign Application Priority Data
Dec. 12, 2008 (KR) 20-2008-0016520

(51) Int. Cl. A61C 15/04

(52) U.S. Cl. 132/323

(57) ABSTRACT

An interdental cleaner with dental floss wherein the dental floss and the interdental cleaner are formed as a single body to increase the convenience of use. The present device makes alternative use of dental floss and interdental cleaner easier and increases convenience of use, by including a body having a handle part which a user grips, a holder fixing both ends of dental floss which are disposed at one end of the body and have a prescribed length, and an interdental cleaner mounted at the other end of the body. Since the interdental cleaner and dental floss of the present device are formed as a single body to be used alternatively according to the situation, the present device has an effect of improving convenience. Additionally, since it is possible to use the bristles of the interdental cleaner alternatively, the present device has an effect of increasing durability of the product.

### BACKGROUND OF THE INVENTION

1. Field of the invention

The present device relates to an interdental cleaner with dental floss. More specifically, the present device relates to an interdental cleaner with dental floss wherein the dental floss and interdental cleaner are formed as a single body so that they can be alternatively used according to a state of the teeth.

2. Description of the Prior Art

In general, as plaque is a combination of calcium and phosphorous components around the teeth, it is a substance formed as a zone between the teeth and gums, if the teeth are not brushed after having a meal. If the plaque is not removed and is left alone, it becomes a hotbed of bacteria and causes tooth diseases.

One example of a tooth disease caused due to plaque is dental calculus. Dental calculus is a deposit which becomes hard like stone after calcium and phosphorous components of saliva are absorbed and calcified when the bacterial plaque stays on the surface of the tooth for a long time. Mostly, since the dental calculus on top of the gums is calcified from the component of saliva, it has a yellow or white color. Additionally, since the dental calculus beneath the gums, that is inside the gums, is formed as calcium and phosphorous come out from the blood of inflamed gums, it has a gray or black color.

Although dental calculus can be prevented, and healthy teeth can be maintained with proper brushing, in order to prevent dental calculus between the teeth where conventional toothbrushes do not reach, dental floss and interdental cleaners are used.

Dental floss is a tool which removes foreign substances from between the teeth, by putting it between the teeth and moving it up and down, and to the front and rear. Although dental floss is mainly used when an interdental cleaner cannot be used due to narrow spaces between the teeth, since it should be used by holding both ends and putting them inside the mouth by hand, it is not convenient.

As the interdental cleaner is a tool wherein a wire, on which a plurality of toothbrush bristles are placed, is twisted and fixed, it is used for removing foreign substances by putting a part having the toothbrush bristles between the teeth. Although an interdental cleaner is convenient to use, it has a disadvantage that if the toothbrush bristles cannot be inserted between the teeth due to a narrow gap between the teeth, it cannot be used.

As mentioned above, it is preferable to use the conventional dental floss and interdental cleaner alternatively according to a use method, or a state of the teeth and a state of the foreign substances between the teeth. That is, if an interdental cleaner cannot be inserted due to the narrow gap between the teeth, dental floss should be used. Also, if hard substances are solidly jammed between the teeth, the substances should be firstly removed with the dental floss and then the interdental cleaner should be used. However, it is inconvenient to carry separate dental floss and interdental cleaner all the time.

### SUMMARY OF THE INVENTION

One aspect of the present device provides an interdental cleaner with dental floss wherein the dental floss and interdental cleaner are formed as a single body convenient to use alternatively according to the use of the dental floss and interdental cleaner, and it is easy to keep and and carry around.

The interdental cleaner with dental floss comprises a body having a handle part which a user grips by hand; a holder fixing both ends of dental floss which are disposed at one end of the body and have a prescribed length; and an interdental cleaner mounted at the other end of the body.

Additionally, the holder is protruded at regular intervals, and both ends of the dental floss are separately fixed on the protruded end.

Also, the interdental cleaner comprises a plurality of toothbrush bristles arranged at prescribed intervals; and a wire having a twist conformation so as to fix the toothbrush bristles, and the interdental cleaner is inserted and fixed to be replaceable in a fitting groove, formed in a prescribed depth at the other end of the body.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective cutaway illustrating the first embodiment of the present device, the interdental cleaner with dental floss;

FIG. 2 is a side view illustrating the interdental cleaner with dental floss; and

FIG. 3 is a side view illustrating the second embodiment of the present device, the interdental cleaner with dental floss.

### DETAILED DESCRIPTION OF THE EXEMPLARY EMBODIMENTS

The detailed description of the interdental cleaner with dental floss, one preferable embodiment of the present device, is as below, by referring to the drawings enclosed herewith.

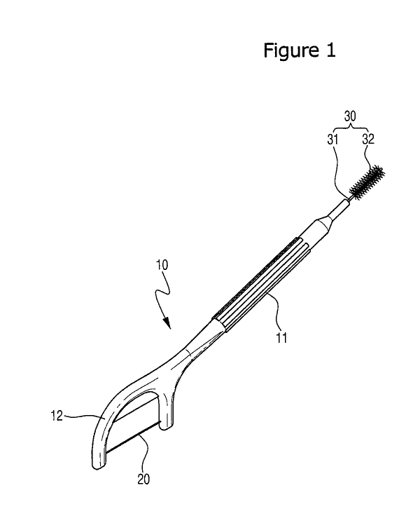

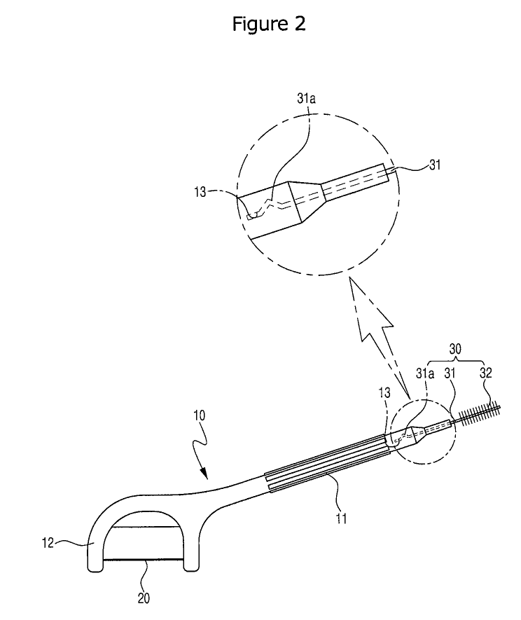

FIG. 1. a perspective cutaway illustrating the first embodiment of the present device, the interdental cleaner with dental floss. FIG. 2 is a side view illustrating the interdental cleaner with dental floss.

As illustrated, the first embodiment of the present device, the interdental cleaner with dental floss is in the form of a stick having a prescribed length, and comprises a body (10) having a handle part (11) which a user grips by hand, a holder (12) disposed at one end of the body (10), and an interdental cleaner (30) mounted at the other end of the body (10).

The holder (12) is protruded as two pillars at prescribed intervals on one end of the body (10), and both ends of the dental floss (20) are fixed at the end of the holder. As illustrated, it is preferable for the holder (12) to have a semicircular arc form in order to be easily inserted into the mouth. Also, although it is not illustrated, the dental floss (20) can be replaced by forming a slit, which can insert the dental floss (20) into the end of the holder (12).

The interdental cleaner (30) comprises a plurality of toothbrush bristles (32) arranged at prescribed intervals, and a wire (31) having a twist conformation so as to fix the toothbrush bristles (32). The toothbrush bristles (32) are fixed by twisting the wire (31) on which the toothbrush bristles (32) are arranged.

Additionally, the end of the wire (31) is combined with the other end of the body (10). The end of the wire (31) is inserted into the other end of the body in regular depths and is fixed to form a single body. Also, the end of the wire (31) comprises a bent portion (31a), which is bent to be protruded as the prescribed intervals in a longitudinal direction, and the other end of the body (10) comprises a fitting groove (13) having a shape corresponding to the end of the wire (31) wherein the bent portion (31a) is formed so as to prevent the wire (31) from easily escaping from the body (10).

The bent portion (31a) can be formed at regular intervals from the end of the wire (31) as illustrated, or can be bent so that the end can make a prescribed angle to the longitudinal direction. At this time, although the bent portion (31a) also can be solidly fixed on the body (10), not be formed on the end of the wire (31), it is preferable to form the bent portion (31a) as above so as to prevent the wire from easily escaping, even for a long-term use.

The interdental cleaner with dental floss, the first preferable embodiment of the present device, can remove foreign substances which are jammed between the teeth, by properly replacing the dental floss (20) formed one side of the body (10) with the interdental cleaner (30) formed on the other side of the body.

In case that the gap between the teeth is too narrow or hard substances are solidly jammed, the dental floss (20) can be used to remove the substances between the teeth, and in case that the gap between the teeth is not narrow enough for interdental cleaner (30) to be inserted, or a removal of hard substances is completed, the interdental cleaner (30) can be used to completely remove the substances between the teeth.

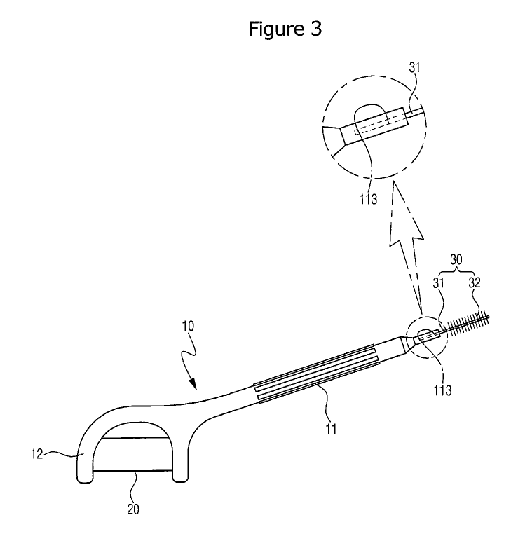

As illustrated in FIG. 3, the interdental cleaner with dental floss, the second preferable embodiment of the present device, comprises a fitting groove (113) depressed in prescribed depths on the other end of the body (10) wherein the end of the wire (31) is inserted into the fitting groove (113) and fixed thereon. That is, it is possible to replace the interdental cleaner (30), which is inserted into the fitting groove (113) and fixed thereon. Other structures and operations are the same as the first preferable embodiment of the present device.

Since the interdental cleaner and dental floss of the present device are formed as a single body to be used alternatively according to the situation, the present device has an effect of improving convenience.

Additionally, since it is possible to use the bristles of the interdental cleaner alternatively, the present device has an effect of increasing durability of the product.

The present device is not limited with specific preferable embodiments mentioned above. Additionally, the present device is easily changeable by a person skilled in the art within the point of the present device claimed in the claims, and the above change falls within the scope of the claims.

What is claimed is:

1. An interdental cleaner with dental floss, comprising a body having a handle part which a user grips by hand; a holder fixing both ends of dental floss which are disposed at one end of the body and have a prescribed length; and an interdental cleaner mounted at the other end of the body.

2. The interdental cleaner with dental floss according to claim 1, wherein the holder is protruded at regular intervals, and both ends of the dental floss are separately fixed on the protruded end.

3. The interdental cleaner with dental floss according to claim 1, wherein the interdental cleaner comprises a plurality of toothbrush bristles arranged at prescribed intervals; and a wire having a twist conformation so as to fix the toothbrush bristles.

4. The interdental cleaner with dental floss according to claim 3, wherein a bent portion, which is bent to be protruded as the prescribed intervals in a longitudinal direction so as to prevent the wire being detached from the body, is formed on the end of the wire fixed on the body.

5. The interdental cleaner with dental floss according to claim 3, wherein the interdental cleaner is fitted and fixed to be replaceable in a fitting groove, formed in a prescribed depth at the other end of the body.
